(19) United States
(12) Patent Application Publication
(10) Pub. No.: US 2023/0141345 A1
(43) Pub. Date: May 11, 2023

(54) NON-PNEUMATIC TIRE AND WHEEL ASSEMBLY

(71) Applicant: The Goodyear Tire & Rubber Company, Akron, OH (US)

(72) Inventors: Wesley Glenn Sigler, Barberton, OH (US); Nathan Edward Yensho, Akron, OH (US); Ann Elizabeth Myers, Cuyahoga Falls, OH (US); Andrew James Miller, Akron, OH (US); Christopher Dean Fenstermaker, Canfield, OH (US); Arun Kumar Byatarayanapura Gopala, Copley, OH (US); Md Atiqur Rahman Bhuiyan, Copley, OH (US)

(21) Appl. No.: 18/048,194

(22) Filed: Oct. 20, 2022

Related U.S. Application Data
(60) Provisional application No. 63/263,713, filed on Nov. 8, 2021.

(51) Int. Cl. B60C 7/14

(52) U.S. Cl. CPC B60C 7/146; B33Y 80/00

(57) ABSTRACT

A nonpneumatic tire and wheel assembly which includes a wheel, and a spoke ring structure having an inner ring that is mounted on an outer surface of the wheel. The spoke ring structure has a plurality of spoke members, and an outer tread ring is mounted on the outer circumference of the spoke ring.

### FIELD OF THE INVENTION

The invention relates in general to a vehicle wheel, and more particularly to a nonpneumatic tire and wheel assembly.

### BACKGROUND OF THE INVENTION

The pneumatic tire has been the solution of choice for vehicular mobility for over a century. The pneumatic tire is a tensile structure. The pneumatic tire has at least four characteristics that make the pneumatic tire so dominate today. Pneumatic tires are efficient at carrying loads, because all of the tire structure is involved in carrying the load. Pneumatic tires are also desirable because they have low contact pressure, resulting in lower wear on roads due to the distribution of the load of the vehicle. Pneumatic tires also have low stiffness, which ensures a comfortable ride in a vehicle. The primary drawback to a pneumatic tire is that it requires compressed fluid. A conventional pneumatic tire is rendered useless after a complete loss of inflation pressure.

A tire designed to operate without inflation pressure may eliminate many of the problems and compromises associated with a pneumatic tire. Neither pressure maintenance nor pressure monitoring is required. Structurally supported tires such as solid tires or other elastomeric structures to date have not provided the levels of performance required from a conventional pneumatic tire. A structurally supported tire solution that delivers pneumatic tire-like performance would be a desirous improvement.

Non-pneumatic tires are typically defined by their load carrying efficiency. “Bottom loaders” are essentially rigid structures that carry a majority of the load in the portion of the structure below the hub. “Top loaders” are designed so that all of the structure is involved in carrying the load. Top loaders thus have a higher load carrying efficiency than bottom loaders, allowing a design that has less mass.

Thus, an improved non-pneumatic tire is desired that has all the features of the pneumatic tires without the drawback of the need for air inflation is desired. It is also desired to have an improved nonpneumatic tire that has longer tread life as compared to a pneumatic tire of the same size.

### SUMMARY OF THE INVENTION

The invention provides in a first aspect a nonpneumatic tire and wheel assembly comprising: a wheel, a spoke ring structure having a discontinuous inner ring that is mounted on an outer wheel mounting surface of the wheel, wherein the discontinuous inner ring has one or more gaps, wherein the spoke ring structure has a plurality of spoke members, and an outer tread ring mounted on the outer circumference of the spoke ring.

The invention provides in a second aspect a nonpneumatic tire and wheel assembly comprising: a wheel, a spoke ring structure having an inner ring that is mounted on an outer rim mounting surface of the wheel, wherein the spoke ring structure has a plurality of spoke members, and an outer tread ring mounted on the outer circumference of the spoke ring, wherein the wheel is axially recessed within the nonpneumatic tire and wheel assembly.

The invention provides in a third aspect a nonpneumatic tire and wheel assembly comprising: a wheel, a spoke ring structure having an inner ring that is mounted on an outer rim mounting surface of the wheel, wherein the spoke ring structure has a plurality of spoke members, and an outer tread ring mounted on the outer circumference of the spoke ring, wherein at least one of the spoke members has an axially outer edge, wherein the axially outer edge is radiused.

The invention provides in a fourth aspect a nonpneumatic tire and wheel assembly comprising: a wheel, a spoke ring structure having an inner ring that is mounted on an outer rim mounting surface of the wheel, wherein the spoke ring structure has a plurality of spoke members, and an outer tread ring mounted on the outer circumference of the spoke ring, wherein each spoke member has a radially inner portion and a radially outer portion, wherein the radially inner portion has an axial width less than the radially outer portion.

### Definitions

“Aspect Ratio” means the ratio of a tire's section height to its section width.

“Axial” and “axially” means the lines or directions that are parallel to the axis of rotation of the tire.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Breakers” or “Tire Breakers” means the same as belt or belt structure or reinforcement belts.

“Circumferential” means lines or directions extending along the pewheeleter of the surface of the annular tread perpendicular to the axial direction; it can also refer to the direction of the sets of adjacent circular curves whose radii define the axial curvature of the tread as viewed in cross section.

“Radial” and “radially” mean directions radially toward or away from the axis of rotation of the tire.

### BRIEF DESCRIPTION OF THE DRAWINGS

The invention will be described by way of example and with reference to the accompanying drawings in which:

FIG. 1 is a front view of a nonpneumatic tire and wheel assembly of the present invention;

FIG. 2 is a side perspective view of the nonpneumatic tire and wheel assembly of FIG. 1;

FIG. 3A is a front view of a spoke ring assembly, while FIG. 3B is a close up perspective view of a portion of the spoke ring assembly of FIG. 3A;

FIG. 4A is a cross-sectional view of the nonpneumatic tire and wheel assembly, FIG. 4B is close up perspective view of the spoke portion of the wheel of FIG. 4A; FIG. 4C is a cross-sectional perspective view from the right hand side, while FIG. 4D is a cross-sectional perspective view from the left hand side;

FIG. 5 is an exploded view of the nonpneumatic tire and wheel assembly of FIG. 1;

FIG. 6 is an exploded view of the nonpneumatic tire and wheel assembly of FIG. 1 with a second embodiment of the hub cover;

FIG. 7A is a side view of a hub cover, FIG. 7B is a front view of the hub cover, and FIG. 7C is a rear perspective view of the hub cover; and

FIGS. 8A-8C illustrate the nonpneumatic tire and wheel assembly with different diameter hubcap covers.

### DETAILED DESCRIPTION OF THE INVENTION

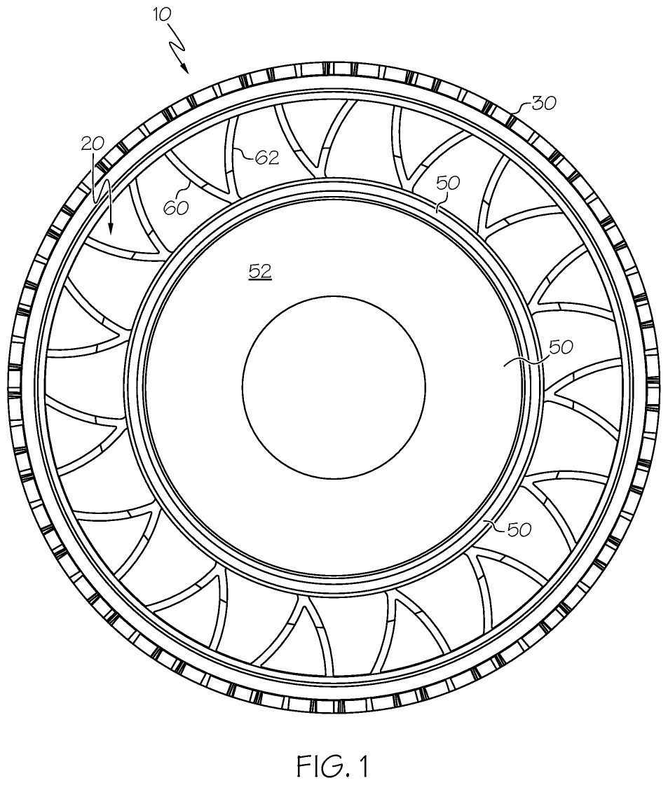

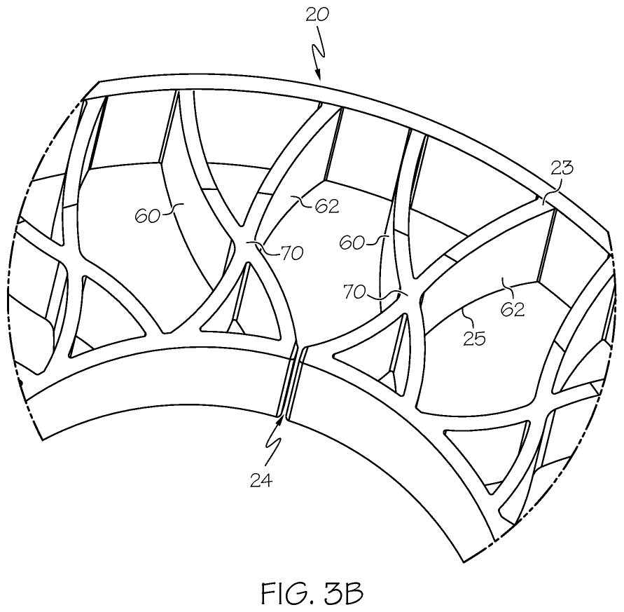

Referring to FIGS. 1 through 5, a nonpneumatic tire and wheel assembly 10 of the present invention is shown. The nonpneumatic tire and wheel assembly 10 includes an outer annular tread ring 30, a spoke ring 20, and a wheel 40. The outer annular tread ring 30 is preferably a one piece annular structure that is formed of a polymer, rubber or other desired elastomer. The tread ring 30 may be molded and cured as a one piece ring, and is mounted on the outer periphery of the spoke ring. The outer tread surface 31 of the tread ring 30 may include tread elements such as ribs, blocks, lugs, grooves, and sipes as desired in order to improve the performance of the tire in various conditions.

The tread ring 30 may optionally include one or more layers 32 of reinforced fabric, wherein the reinforced fabric is preferably formed of parallel reinforcement cords. The reinforcement cords may be nylon, polyester or steel. The reinforced fabric layer 32 is preferably coated with rubber for adhesion to the tread. Alternatively, the tread ring may optionally include one or more layers of rubber coated wire that is spirally wound so that it forms an angle of about zero degrees, so that the wire is oriented in the circumferential direction. More preferably, there are at least two layers of reinforced fabric with no spacing in between.

### Spoke Ring Structure

The nonpneumatic tire and wheel assembly 10 further includes a spoke ring structure 20. The spoke ring structure 20 has an inner portion 22 that is mounted on the wheel rim mounting surface 42. The inner portion 22 is a discontinuous ring divided into two or more segments with gaps 24 between the segments and along the inner radius to allow for ease of assembly with the wheel. Preferably, the inner portion 22 has an interference fit on the outer rim mounting surface 42 of the wheel 40.

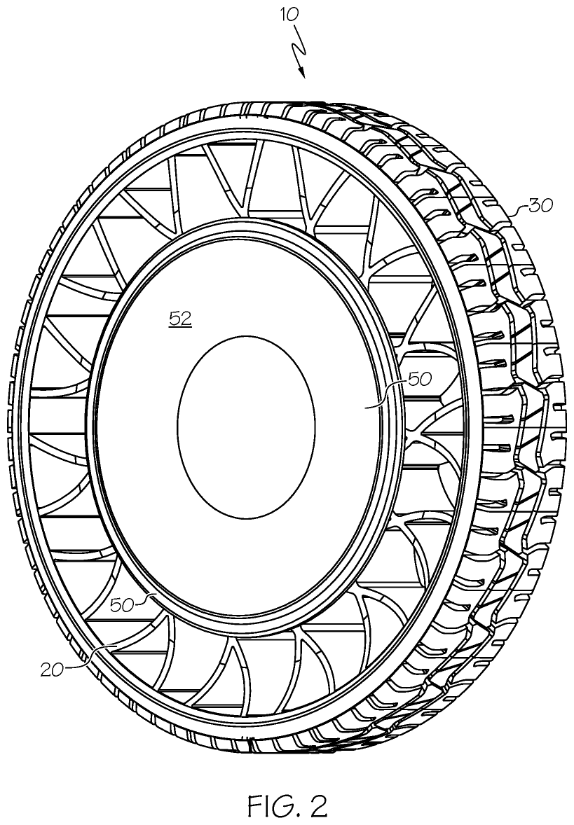

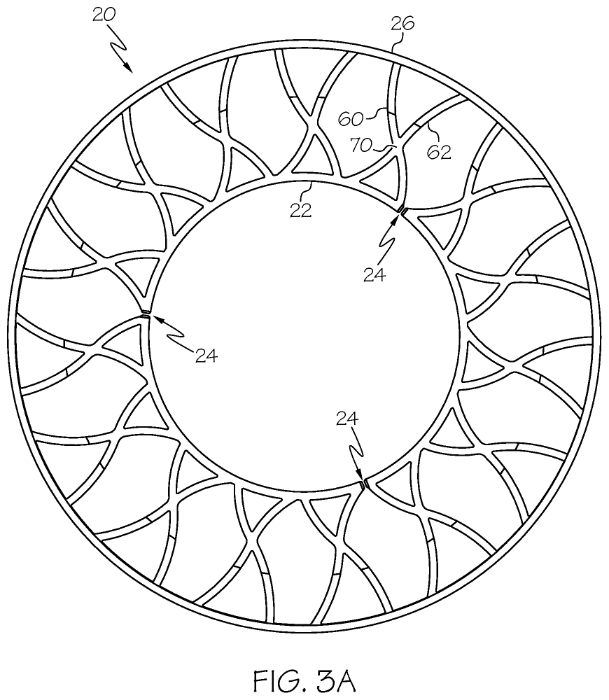

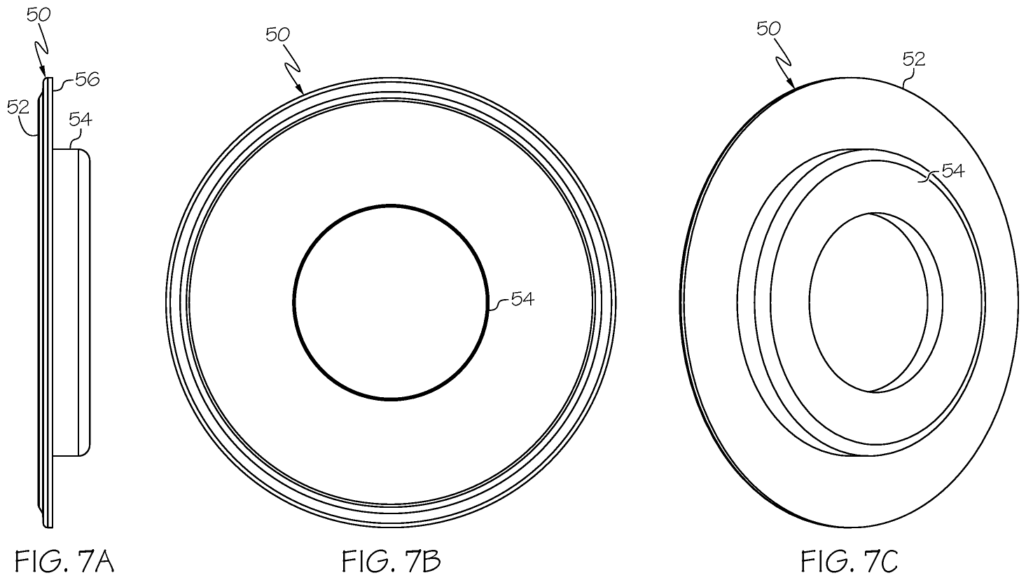

The spoke ring structure further includes an outer ring 26 having an outer surface that is joined to the inner tread surface 34 by an adhesive polymer. The spoke ring structure further includes a plurality of spoke members that extend between an inner portion 22 to the outer ring 26. In a first example shown in FIGS. 2 and 7, the spoke ring structure has a first spoke member 60 that extends from the inner portion 22 to the outer ring 26, preferably at an angle. The spoke ring structure includes a second spoke member 62 that also extends from the inner portion to the outer ring 26, preferably at an angle. The first and second spoke member 60,62 are joined together at a junction 70 to form an X shaped spoke. The first and second spoke members 60,62 may be straight or curved. The number of spokes may vary, for example, from 15 to 30 depending upon the vehicle weight and desired spring rate.

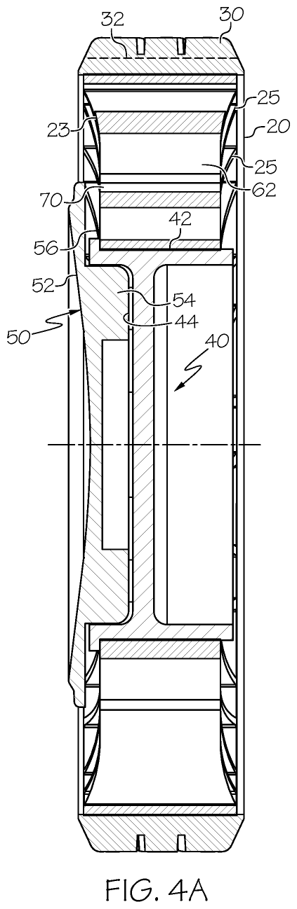

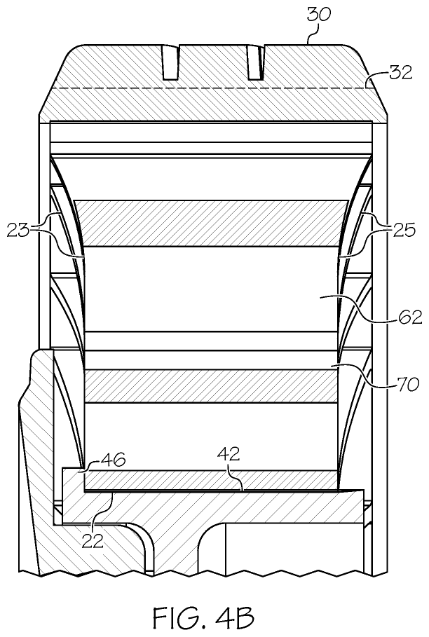

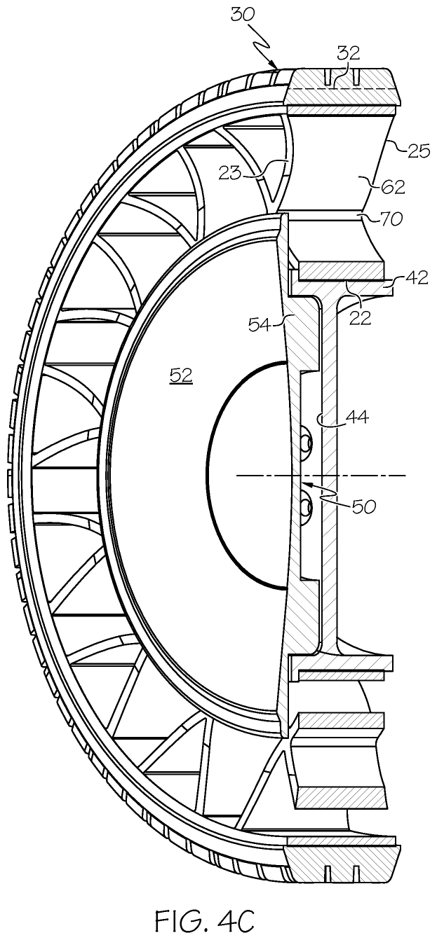

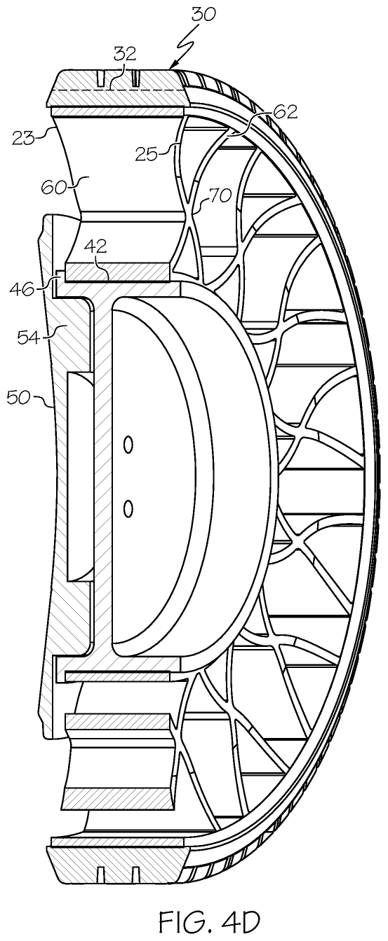

As shown in cross-section in FIG. 4A, the inner portion 22 of the spoke ring structure 20 is mounted on the outer rim mounting surface 42 of the wheel. The axial thickness of the inner portion of the spoke structure is preferably less than the axial thickness of the outer ring 26, allowing the wheel to be recessed inwards of the outer ring of the spoke ring structure, as shown in FIG. 4B. The spoke ring structure has axially outer edges 23,25 that are radiused or scalloped. The radius R of the radiused outer edges may range from 0.5 to 2 in, and more preferably from 1 to 1.5 inches. The scalloped or radiused outer edges allow the wheel to be recessed axially inward of the spoke and tread ring structure. Furthermore, the axial width of a radially outer portion of one or more of the spoke members is greater than the axial width of the radially inner portion of the one or more spoke members. Additionally, it is preferred that there is a single spoke ring structure 20 mounted on the wheel.

The spoke ring structure 20 is preferably an integrally formed annular structure preferably made of a resilient and/or moldable polymeric material such as but not limited to, a thermoplastic elastomer, natural rubber, styrene butadiene rubber, polybutadiene rubber or EPDM rubber or a blend of two or more of these materials which can be utilized in either injection molding or compression molding. The material of the spoke ring structure is selected based upon one or more of the following material properties. The tensile (Young's) modulus of the spoke disk material is preferably in the range of 5 MPa to 100 MPa, and more preferably in the range of 10 MPa to 70 MPa.

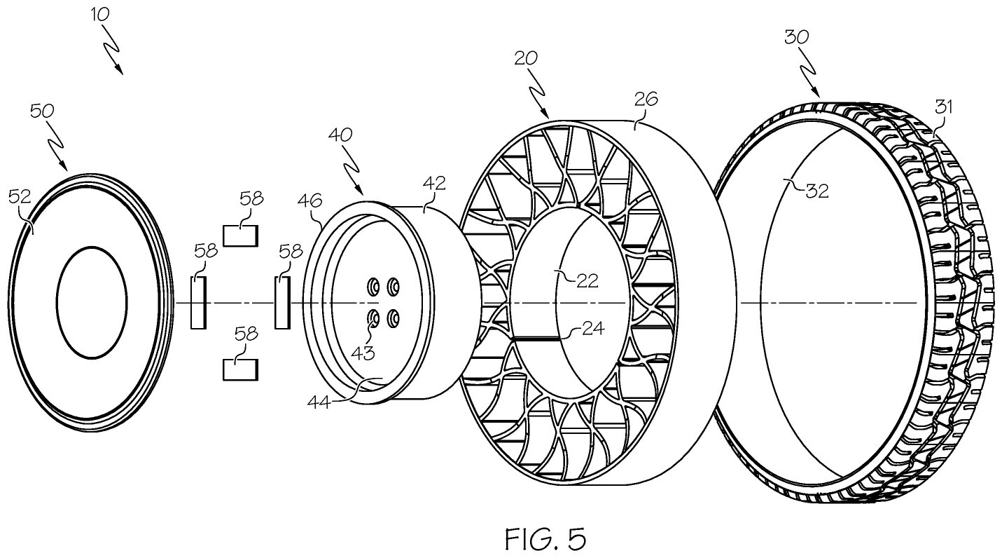

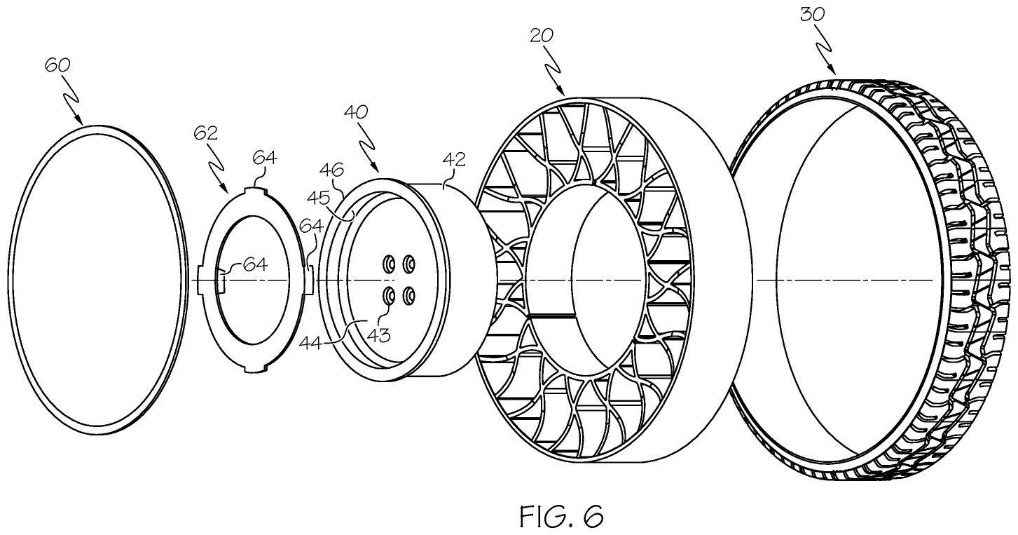

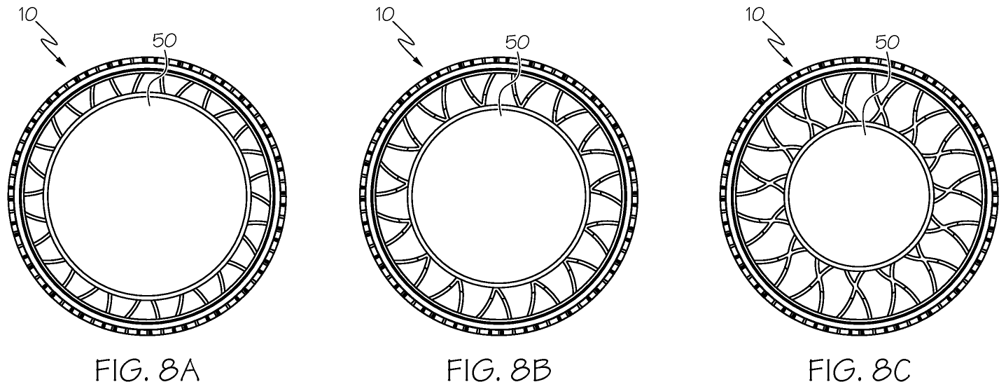

The wheel 40 is shown in FIG. 5, and has an annular outer rim mounting surface 42 for receiving the inner portion 22 of the spoke ring structure 20. The wheel further includes a recessed inner disk portion 44 having a plurality of bolt holes 43 for connecting the wheel assembly to a vehicle. The inner disk portion 44 is surrounded by an outer flange 46. The wheel 40 may include an optional hub cover 50. The hub cover 50 has an outer display surface 52 that can be used to display company logos or designs. The hub cover 50 has an inner surface 56 that has a mounting ring 54 for reception into the recessed inner disk portion. The mounting ring 54 is secured to the inner disk portion by adhesive, or adhesive strips 58 or by hook and loop fastener strips. As shown in FIGS. 8A-8C, the hub cover may have varying diameters to cover the spoke ring structure. Although not shown, the hub cover may completely cove the spoke ring structure to prevent road debris from clogging the spoke structure. FIG. 6 illustrates an alternate embodiment of the hub cap structure 60, wherein the hub cap comprises a flat disk 60 with a removable ring insert 62 that may be secured by adhesion to the flat disk inner surface 62. The ring insert has retainers 64 which are received within the flange of the wheel and secured thereto by adhesive.

In one example, the tire of the present invention is provided on a mobile delivery vehicle. The mobile delivery vehicle has at least three, preferably four or more nonpneumatic tire and wheel assemblies of the present invention, and more particularly, six nonpneumatic tire and wheel assemblies. The tire has an outer rubber tread and a spoke ring structure that is injection molded and formed of a polyurethane material having a tensile modulus of about 20-25 MPA. The spoke ring structure may also be three dimensionally printed. The nonpneumatic tire and wheel of the present invention has a spring rate in the range of 250 to 300 pounds per inch. The nonpneumatic tire and wheel of the present invention has an axial width of about 1.5 inches with 36 X shaped spokes having a radial height of about 1 inch. While the nonpneumatic tire and wheel assembly is described as having X shaped spokes, other spoke designs could be used. The wheel has an outer diameter of about 5 inches, but could be sized to be smaller in the outer diameter to provide a greater radial height of the spoke ring structure. The weight of the tire is 570 grams and is designed for a minimum tread life of 5000 km, preferably 20,000 km or more.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A nonpneumatic tire and wheel assembly comprising:
a wheel, a spoke ring structure having a discontinuous inner ring that is mounted on an outer wheel mounting surface of the wheel, wherein the discontinuous inner ring has one or more gaps, wherein the spoke ring structure has a plurality of spoke members, and an outer tread ring mounted on the outer circumference of the spoke ring.

2. The nonpneumatic tire and wheel assembly of claim 1 wherein the tread ring has one or more layers of fabric reinforcement.

3. The nonpneumatic tire and wheel assembly of claim 2 wherein the fabric is formed of a plurality of parallel reinforcement cords.

4. The nonpneumatic tire and wheel assembly of claim 1 wherein the spoke members of the spoke ring structure are joined together at a junction to form an X shaped spoke.

5. The nonpneumatic tire and wheel assembly of claim 1 wherein the wheel is recessed within the tire and wheel assembly.

6. The nonpneumatic tire and wheel assembly of claim 1 wherein the inner portion of the spoke ring structure has an axial width less than the axial width of the outer spoke ring.

7. The nonpneumatic tire and wheel assembly of claim 1 wherein each spoke member has a radially inner portion that has an axial width less than an axial width of a radially outer portion of the spoke member.

8. The nonpneumatic tire and wheel assembly of claim 1 wherein each spoke member has an axially outer edge, wherein at least one of the axially outer edges is radiused.

9. The nonpneumatic tire and wheel assembly of claim 1 wherein the nonpneumatic tire and wheel assembly is formed by three dimensional printing.

10. The nonpneumatic tire and wheel assembly of claim 1 wherein the spoke ring structure is formed of a polymer material having a tensile modulus in the range of 15 to 100 mpa.

11. A nonpneumatic tire and wheel assembly comprising:
a wheel, a spoke ring structure having an inner ring that is mounted on an outer rim mounting surface of the wheel, wherein the spoke ring structure has a plurality of spoke members, and an outer tread ring mounted on the outer circumference of the spoke ring, wherein the wheel is axially recessed within the nonpneumatic tire and wheel assembly.

12. A nonpneumatic tire and wheel assembly comprising: a wheel, a spoke ring structure having an inner ring that is mounted on an outer rim mounting surface of the wheel, wherein the spoke ring structure has a plurality of spoke members, and an outer tread ring mounted on the outer circumference of the spoke ring, wherein at least one of the spoke members has an axially outer edge, wherein the axially outer edge is radiused.

13. A nonpneumatic tire and wheel assembly comprising: a wheel, a spoke ring structure having an inner ring that is mounted on an outer rim mounting surface of the wheel, wherein the spoke ring structure has a plurality of spoke members, and an outer tread ring mounted on the outer circumference of the spoke ring, wherein each spoke member has a radially inner portion and a radially outer portion, wherein the radially inner portion has an axial width less than the radially outer portion.
